(19) United States
(12) Patent Application Publication
(10) Pub. No.: US 2022/0092573 A1
(43) Pub. Date: Mar. 24, 2022

(54) PORTABLE TERMINAL AND INFORMATION PROCESSING METHOD FOR A PORTABLE TERMINAL

(71) Applicant: TOSHIBA TEC KABUSHIKI KAISHA, Tokyo (JP)

(72) Inventor: Koichi SUGIYAMA, Izunokuni Shizuoka (JP)

(21) Appl. No.: 17/351,925

(22) Filed: Jun. 18, 2021

(30) Foreign Application Priority Data
Sep. 23, 2020 (JP) 2020-158824

(51) Int. Cl. G06Q 20/20; H04W 4/029; H04W 4/33

(52) U.S. Cl. CPC G06Q 20/208; G06Q 20/202; H04W 4/33; H04W 4/029

(57) ABSTRACT

According to an embodiment, a portable terminal registers, in a product-to-be-purchased table, information regarding a product to be purchased specified by image data generated by an imaging device. The portable terminal registers, in a product registration table, information regarding a product specified by identification information input by an input device. Further, the portable terminal displays a screen regarding account processing of the product whose information is registered in the product registration table.

### CROSS-REFERENCE TO RELATED APPLICATIONS

This application is based upon and claims the benefit of priority from the prior Japanese Patent Application No. 2020-158824, filed on Sep. 23, 2020, the entire contents of which are incorporated herein by reference.

### FIELD

An embodiment to be described here generally relates to a portable terminal and an information processing method for a portable terminal.

### BACKGROUND

In the past, there has been known a technology for creating, by a portable terminal, a shopping list in which a product to be purchased is registered. Further, in recent years, an increasing number of retail stores have customers perform account processing by themselves.

However, the existing portable terminal creates a shopping list, while the existing portable terminal cannot have customers perform the account processing by themselves.

### BRIEF DESCRIPTION OF THE DRAWINGS

FIG. 1 is a block diagram showing an example of a product sales system according to an embodiment;

FIG. 2 is a block diagram showing an example of a hardware configuration of a portable terminal according to the embodiment;

FIG. 3 is a diagram showing an example of a data configuration of a product-to-be-purchased table according to the embodiment;

FIG. 4 is a diagram showing an example of a data configuration of a product registration table according to the embodiment;

FIG. 5 is a block diagram showing an example of a hardware configuration of a store server according to the embodiment;

FIG. 6 is a diagram showing an example of a data configuration of a product master according to the embodiment;

FIG. 7 is a block diagram showing an example of a hardware configuration of an accounting apparatus according to the embodiment;

FIG. 8 is a block diagram showing a characteristic functional configuration of respective apparatuses of a product sales system according to the embodiment;

FIG. 9 is a flowchart showing an example of out-of-store processing executed by a portable terminal according to the embodiment; and

FIG. 10 is a flowchart showing an example of in-store processing executed by the portable terminal according to the embodiment.

### DETAILED DESCRIPTION

According to an embodiment, a portable terminal executes account processing of a purchase-target product. The portable terminal includes an imaging device, an input device, a storage device, a display device, and a controller. The imaging device images a product and generates image data of the imaged product. The input device inputs identification information for specifying the product. The storage device stores a product-to-be-purchased table for registering information regarding a product to be purchased, and a product registration table for registering information regarding a purchase-target product. The display device displays a processing screen regarding the product to be purchased and the purchase-target product. The controller registers, where the product to be purchased is imaged by the imaging device, information regarding a product specified by the image data generated by the imaging device in the product-to-be-purchased table. The controller registers, where identification information for specifying the purchase-target product is input by the input device after the information regarding a product is registered in the product-to-be-purchased table, information regarding a product specified by the input identification information in the product registration table. Further, the controller displays, on the display device, a screen regarding account processing of the product whose information is registered in the product registration table.

An embodiment of a portable terminal and an information processing method for the portable terminal will be described below in detail with reference to the drawings. In the drawings, the same reference symbols will denote the same or similar portions. The embodiment described below is merely an example of the portable terminal and the information processing method for the portable terminal, and does not limit the configurations, specifications, and the like of the embodiment.

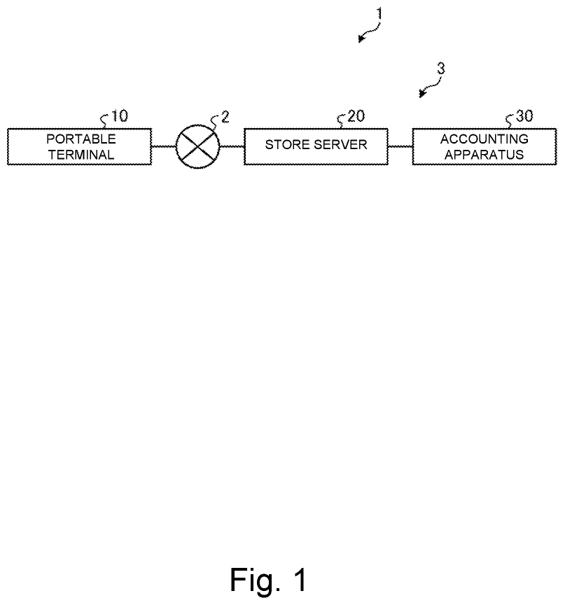

FIG. 1 is a block diagram showing an example of a product sales system 1 according to this embodiment. The product sales system 1 includes a portable terminal 10 and a store system 3. The portable terminal 10 and the store system 3 are communicably connected to each other via a network 2 such as the Internet. Further, the store system 3 includes a store server 20 and an accounting apparatus 30. The store server 20 and the accounting apparatus 30 are communicably connected to each other via a network in a store. Note that the product sales system 1 shown in FIG. 1 is merely an example, and the number of various apparatuses may be arbitrarily changed. Further, the product sales system 1 may include a plurality of store systems 3.

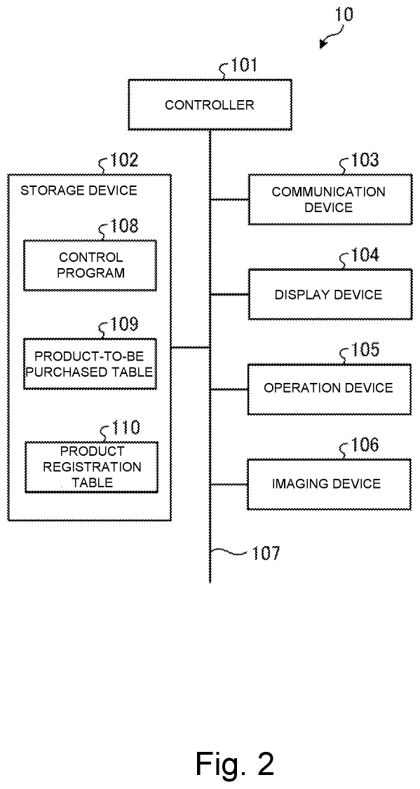

The portable terminal 10 is a customer-portable terminal such as a smartphone and a tablet terminal. The portable terminal 10 registers, as a product to be purchased, a product specified by image data of a product imaged by an imaging device 106 (see FIG. 2). Further, the portable terminal 10 executes product registration processing for registering a purchase-target product in a retail store. Further, the portable terminal 10 displays a screen regarding account processing of the product registered by the product registration processing.

For example, the portable terminal 10 displays a screen for causing the accounting apparatus 30 to execute account processing. For example, the portable terminal 10 displays, in the case where accounting information such as a product code registered by the product registration processing and the total amount of products is transmitted to the accounting apparatus 30 by short-range wireless communication or wireless communication, a screen for guiding the transmission of the accounting information. Further, the portable terminal 10 displays, in the case where the accounting apparatus 30 is caused to read a code symbol such as a two-dimensional code representing the accounting information, a screen in which the code symbol is displayed.

Alternatively, the portable terminal 10 displays a screen for executing the account processing in the portable terminal 10 itself. For example, the portable terminal 10 displays a screen for inputting information of a credit card or the like used for the account processing.

The store server 20 is an information processing apparatus such as a personal computer and a server apparatus. The store server 20 stores a product master file 208 (hereinafter, referred to as the product master 208) having information regarding the product being sold at the retail store. For example, the store server 20 makes an inquiry about, in the case where the portable terminal 10 images a product, the product of the obtained image data.

The accounting apparatus 30 is an apparatus that executes account processing by customers themselves. For example, the accounting apparatus 30 executes, on the basis of the accounting information acquired from the portable terminal 10, account processing of the products registered in the product registration processing by the portable terminal 10.

Next, a hardware configuration of various apparatuses included in the product sales system 1 will be described.

FIG. 2 is a block diagram showing an example of a hardware configuration of the portable terminal 10. The portable terminal 10 includes a controller 101, a storage device 102, a communication device 103, a display device 104, an operation device 105, and an imaging device 106. These devices are connected to each other via a system bus 107 such as a data bus and an address bus.

The controller 101 is a computer that controls the operation of the entire portable terminal 10 and realizes various functions of the portable terminal 10. The controller 101 includes a processor and a memory. The processor is, for example, a CPU (Central Processing Unit). The memory includes, for example, a ROM (Read Only Memory) and a RAM (Random Access Memory). The CPU integrally controls the operation of the portable terminal 10. The ROM is a storage medium for storing various programs and data. The RAM is a storage medium for temporarily storing various programs and various types of data. The CPU uses the RAM as a work area and executes a program stored in the ROM, the storage device 102, or the like.

The storage device 102 includes a flash memory or the like. The storage device 102 stores a control program 108, a product-to-be-purchased table 109, and a product registration table 110. The product-to-be-purchased table 109 and the product registration table 110 do not necessarily need to be stored in the portable terminal 10 and may be stored in another apparatus. Further, the product-to-be-purchased table 109 and the product registration table 110 do not necessarily need to be stored in one apparatus and may be stored in a plurality of apparatuses in a distributed manner.

The control program 108 is a program for exhibiting the functions provided by the operating system and the portable terminal 10. The control program 108 includes a program for exhibiting characteristic functions according to this embodiment.

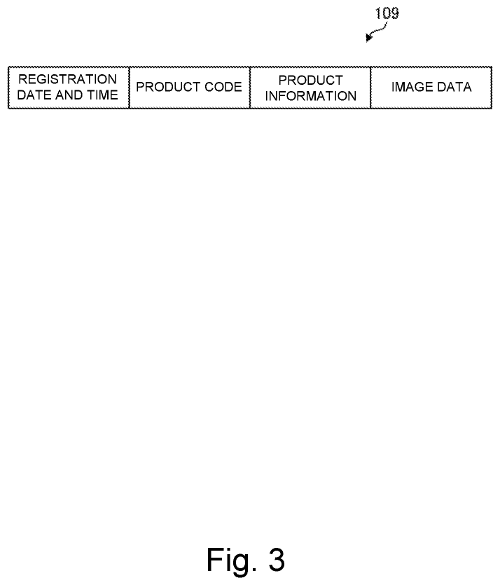

FIG. 3 is a diagram showing an example of a data configuration of the product-to-be-purchased table 109. The product-to-be-purchased table 109 is an information table for registering information regarding a product to be purchased. That is, the product-to-be-purchased table 109 is a list of products to be purchased. More specifically, in the product-to-be-purchased table 109, a registration date and time, a product code, product information, and image data are registered in association with each other. The registration date and time represents information indicating the date and time when a product was registered as a product to be purchased. The product code represents identification information for specifying a product to be purchased. The product information is information such as the name, price, and the like of a product to be purchased. The image data is image data of a product imaged to register the product as a product to be purchased.

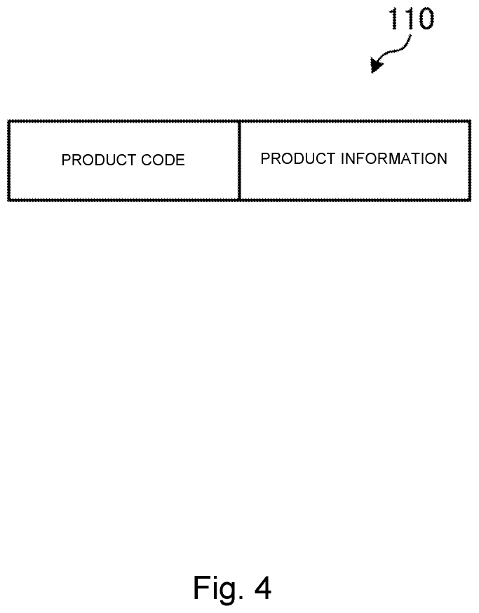

FIG. 4 is a diagram showing an example of a data configuration of the product registration table 110. The product registration table 110 is an information table having information regarding a product registered by the product registration processing of registering a purchase-target product in a retail store. More specifically, in the product registration table 110, the product code and the product information are registered in association with each other. The product code represents identification information for specifying a purchase-target product. The product information is information such as the name, price, and the like of a purchase-target product.

The communication device 103 is an interface for communicating with another apparatus via the network 2. For example, the communication device 103 communicates with the store server 20.

The display device 104 displays a processing screen regarding a product to be purchased and a purchase-target product. The display device 104 includes, for example, a liquid crystal display. The operation device 105 is an input device such as a touch pad that accepts various operations by detecting a touched position on the screen of the display device 104. Note that the operation device 105 may be a hardware button or the like.

The imaging device 106 is a camera including an image sensor such as a CMOS (Complementary Metal-Oxide Semiconductor) and a CCD (Charge Coupled Device). For example, the imaging device 106 generates image data by imaging a product.

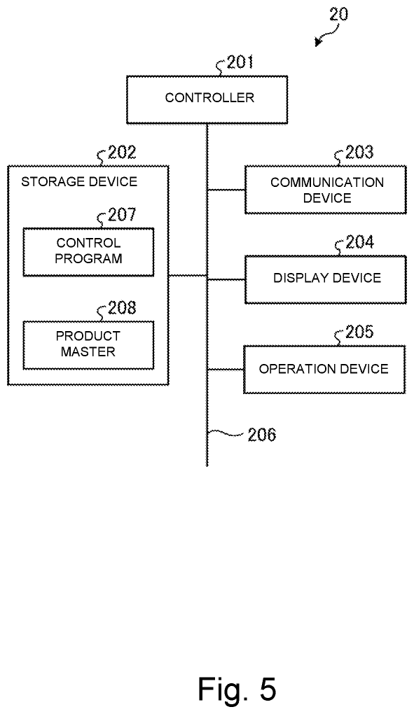

FIG. 5 is a block diagram showing an example of a hardware configuration of the store server 20. The store server 20 includes a controller 201, a storage device 202, a communication device 203, a display device 204, and an operation device 205. These devices are connected to each other via a system bus 206 such as a data bus and an address bus.

The controller 201 is a computer that controls the operation of the entire store server 20 and realizes various functions of the store server 20. The controller 201 includes a processor and a memory. The processor is, for example, a CPU. The memory includes, for example, a ROM and a RAM. The processor integrally controls the operation of the store server 20. The ROM is a storage medium for storing various programs and data. The RAM is a storage medium for temporarily storing various programs and various types of data. The processor uses the RAM as a work area and executes a program stored in the ROM, the storage device 202, or the like.

The storage device 202 includes an HDD (Hard Disk Drive), an SSD (Solid State Drive), or the like. The storage device 202 stores a control program 207 and the product master 208. The product master 208 does not necessarily need to be stored in the store server 20 and may be stored in another apparatus.

Further, the product master 208 does not necessarily need to be stored in one apparatus and may be stored in a plurality of apparatuses in a distributed manner.

The control program 207 is a program for exhibiting the functions provided by the operating system and the store server 20. The control program 207 includes a program for exhibiting characteristic functions according to this embodiment.

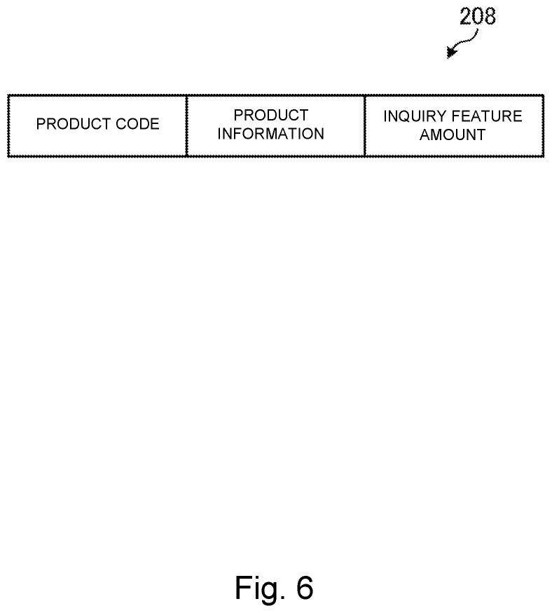

FIG. 6 is a diagram showing an example of a data configuration of the product master 208. The product master 208 is an information master having information regarding a product. The product master 208 stores a product code, product information, and inquiry feature amount in association with each other. The product code represents identification information for specifying a product. The product information is information such as the name and price of a product. The inquiry feature amount is a feature amount for making an inquiry about a product. The inquiry feature amount represents information in which external characteristics such as a color, a shape, a design, and a concavo-convex state of a product are parameterized.

The communication device 203 is an interface for communicating with another apparatus via the network 2. For example, the communication device 203 is a network card for wired or wirelessly connecting to the network 2.

The display device 204 includes, for example, a liquid crystal display. The operation device 205 is, for example, an input device such as a keyboard and a mouse.

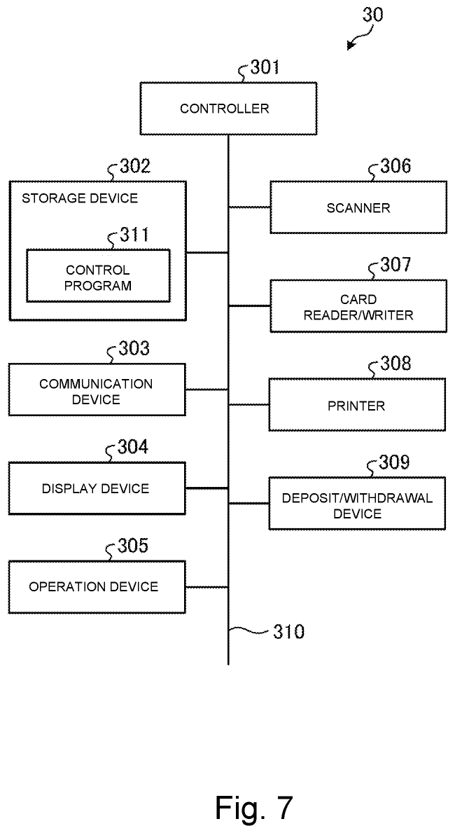

FIG. 7 is a block diagram showing an example of a hardware configuration of the accounting apparatus 30. The accounting apparatus 30 includes a controller 301, a storage device 302, a communication device 303, a display device 304, an operation device 305, a scanner 306, a card reader/writer 307, a printer 308, and a deposit/withdrawal device 309. These devices are connected to each other via a system bus 310 such as a data bus and an address bus.

The controller 301 is a computer that controls the operation of the entire accounting apparatus 30 and realizes various functions of the accounting apparatus 30. The controller 301 includes a processor and a memory. The processor is, for example, a CPU. The memory includes a ROM and a RAM. The processor integrally controls the operation of the accounting apparatus 30. The ROM is a storage medium for storing various programs and data. The RAM is a storage medium for temporarily storing various programs and various types of data The processor uses the RAM as a work area and executes a program stored in the ROM, the storage device 302, or the like.

The storage device 302 includes an HDD, an SSD, or the like. The storage device 302 stores a control program 311. The control program 311 is a program for exhibiting the functions provided by the operating system and the accounting apparatus 30. The control program 311 includes a program for exhibiting characteristic functions according to this embodiment.

The communication device 303 is an interface for communicating with another apparatus via a network. For example, the communication device 303 is a network card for wired or wirelessly connecting to the network.

The display device 304 includes a liquid crystal display, an organic EL display, or the like. The operation device 305 is an input device such as a keyboard and a mouse.

The scanner 306 reads a code symbol such as a bar code and a two-dimensional code. The scanner 306 may be a reading device that reads a code image by using reflection of a laser beam, or may be a reading device that reads a code image from an image of a product captured by an image sensor such as a CMOS and a CCD.

The card reader/writer 307 reads/writes information from/to a card such as a credit card.

The printer 308 issues a receipt on which the item, the amount, and the like in one transaction are printed.

The deposit/withdrawal device 309 houses the money put into a deposit slot and discharges money to a discharge port.

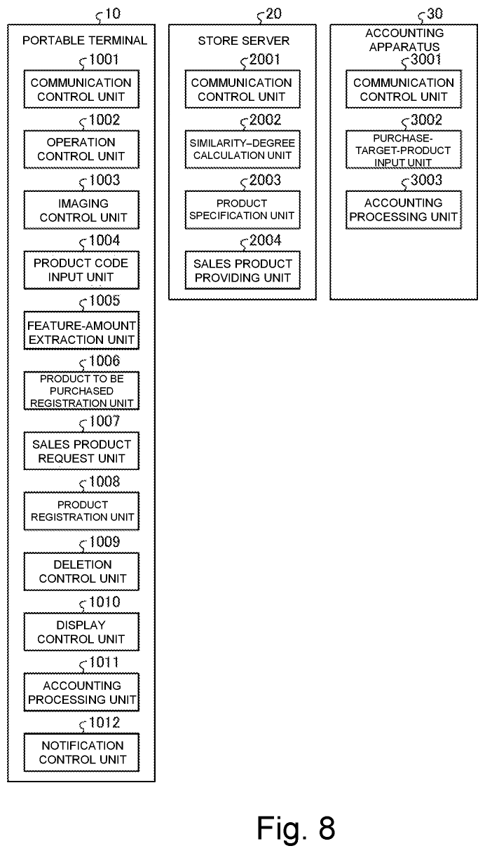

Next, characteristic functions of the respective apparatuses included in the product sales system 1 will be described. FIG. 8 a block diagram showing a characteristic functional configuration of the respective apparatuses of the product sales system 1.

The controller 101 of the portable terminal 10 expands the control program 108 stored in the storage device 102 in the RAM and operates in accordance with the control program 108, thereby generating each function unit in the RAM. Specifically, the controller 101 of the portable terminal 10 executes the functions of a communication control unit 1001, an operation control unit 1002, an imaging control unit 1003, a product code input unit 1004, a feature-amount extraction unit 1005, a product-to-be-purchased registration unit 1006, a sales product request unit 1007, a product registration unit 1008, a deletion control unit 1009, a display control unit 1010, an account processing unit 1011, and a notification control unit 1012 shown in FIG. 8 as the function units.

The communication control unit 1001 controls the communication device 103 to communicate with, for example, the store server 20 via the network 2.

The operation control unit 1002 controls the operation device 105 to accept various operations.

The imaging control unit 1003 controls the imaging device 106 to cause the imaging device 106 to image various subjects. For example, the imaging control unit 1003 generates image data of a product by causing the imaging device 106 to image the product. In the case where an operator creates a list of products to be purchased, i.e., in the case where an operator registers products to be purchased in the product-to-be-purchased table 109, the operator uses the imaging device 106 to image products to be purchased, outside the store (e.g., at home). The product that is a subject to be imaged in this case includes the product itself, a photograph of the product, a code symbol indicating the product, or the like. Further, in the case where the operator performs registration processing of a purchase-target product, i.e., in the case where the operator registers a purchase-target product in the product registration table 110, the operator uses the imaging device 106 to image a purchase-target product (product itself), in the store. Note that in the case where the imaging device 106 is caused to image a purchase-target product, the imaging control unit 1003 displays, on the display device 104, a screen (product registration screen) in which a frame line is superimposed on the image of the imaged product. In this regard, the operator causes the imaging device 106 to image the product so that the product is disposed inside the frame line. The image data of the product that the imaging control unit 1003 has caused the imaging device 106 to image is used for image data for reading the code symbol such as a bar code attached to the product and image data for recognizing the product by object recognition.

The product code input unit 1004 reads a product code for specifying the product. More specifically, the product code input unit 1004 decodes a code symbol in the case where the code symbol is included in the image of the product that the imaging control unit 1003 has caused the imaging device 106 to image. In this way, the product code input unit 1004 accepts the input of the product code indicated by the code symbol. In the case where the product code input unit 1004 accepts the input of the product code, the product code input unit 1004 causes the communication control unit 1001 to transmit, to the store server 20, provision request information for requesting the provision of the product information of the product specified by the product code.

The feature-amount extraction unit 1005 extracts, in the case where the product code input unit 1004 has not accepted the input of the product code, a feature amount of the product from the image data of the product that the imaging control unit 1003 has caused the imaging device 106 to image. Note that in the case where the imaging device 106 is caused to image the product, the imaging control unit 1003 displays, on the display device 104, a screen (product registration screen) to which a frame line is added. The feature-amount extraction unit 1005 extracts the feature amount from the inside of the frame line to extract the feature amount of the product from the image data of the product that the imaging control unit 1003 has caused the imaging device 106 to image. In the case where the feature-amount extraction unit 1005 has extracted the feature amount of the product from the image data, the feature-amount extraction unit 1005 causes the communication control unit 1001 to transmit, to the store server 20, the product inquiry information having the extracted feature amount.

The product-to-be-purchased registration unit 1006 registers the product to be purchased in the product-to-be-purchased table 109. The product-to-be-purchased registration unit 1006 registers, in the product-to-be-purchased table 109, the product specified by the product code accepted by the product code input unit 1004. Specifically, in the case where the product-to-be-purchased registration unit 1006 has received product information from the store server 20 as a response to the above-mentioned provision request information of the product code input unit 1004, the product-to-be-purchased registration unit 1006 registers, in the product-to-be-purchased table 109 (see FIG. 3), the accepted product code, the received product information, the image data of the imaged product, and the registration date and time.

The product-to-be-purchased registration unit 1006 registers, in a list of products to be purchased, the product specified by the image data of the product imaged by the imaging device 106. The product-to-be-purchased registration unit 1006 is an example of a first registration unit. That is, the product-to-be-purchased registration unit 1006 registers, in the product-to-be-purchased table 109, the product specified by the feature amount extracted by the feature-amount extraction unit 1005. Specifically, in the case where the product-to-be-purchased registration unit 1006 has received the product code and the product information from the store server 20 as a response to the above-mentioned product inquiry information of the feature-amount extraction unit 1005, the product-to-be-purchased registration unit 1006 registers, in the product-to-be-purchased table 109 (see FIG. 3), the received product code, the received product information, the image data of the imaged product, and the registration date and time.

In the case where the sales product request unit 1007 detects that a customer has entered the retail store, the sales product request unit 1007 requests, for example, the store server 20 for a list of products sold in the retail store that the customer has entered, of the products registered in the product-to-be-purchased table 109. More particularly, the sales product request unit 1007 detects that a customer having the portable terminal 10 has entered the retail store. The sales product request unit 1007 is an example of a detection unit. Note that the detection method is not limited. For example, the sales product request unit 1007 receives position information indicating the position of the portable terminal 10. The sales product request unit 1007 then detects the entry by comparing the position information indicating the position of the portable terminal 10 with the position information indicating the position of the retail store. Alternatively, the sales product request unit 1007 detects that the customer has entered the retail store by executing short-range wireless communication with an apparatus installed in the retail store. Alternatively, the sales product request unit 1007 detects that the customer has entered the retail store by accepting the operation of the customer indicating that the customer has entered the retail store.

The sales product request unit 1007 causes, in the case where the sales product request unit 1007 detects that a customer has entered the retail store, the communication control unit 1001 to transmit the product-to-be-purchased table 109 to the store server 20. In the case where the communication control unit 1001 (the communication device 103) has received sales product list information indicating the list of products sold in the retail store, of the products registered in the product-to-be-purchased table 109, the sales product request unit 1007 displays the sales product list information on the display control unit 1010 (display device). Thus, in the case where the sales product request unit 1007 has detected the entry of the customer, the display control unit 1010 displays, on the display device 104, a list of products sold in the retail store of the products included in the product-to-be-purchased table 109.

The product registration unit 1008 registers a purchase-target product in the product registration table 110 by processing similar to that by the product-to-be-purchased registration unit 1006. More specifically, the imaging control unit 1003 causes the imaging device 106 to image a product and generates image data, thereby accepting the input of the product code. Further, the communication control unit 1001 receives the product code and the product information from the store server 20 as a response to the above-mentioned product inquiry information having the feature amount extracted from the image data of the product that the imaging control unit 1003 has caused the imaging device 106 to image. That is, the imaging control unit 1003 or the communication control unit 1001 accepts the input of the product code for specifying the product. The imaging control unit 1003, or the communication control unit 1001 is an example of an input unit. The product registration unit 1008 registers the product specified by the product code as the purchase-target product in the product registration table 110. The product registration unit 1008 is an example of a second registration unit.

The deletion control unit 1009 deletes, in the case where a purchase-target product is included in the product-to-be-purchased table 109, the purchase-target product from the product-to-be-purchased table 109. The deletion control unit 1009 is an example of a deletion unit. More specifically, the deletion control unit 1009 determines, in the case where the product registration unit 1008 has registered a product in the product registration table 110, whether or not the same product code as the product code of the registered product is registered in the product-to-be-purchased table 109. The deletion control unit 1009 deletes, in the case where the same product code is registered in the product-to-be-purchased table 109, the same product code from the product-to-be-purchased table 109. Note that the timing of deleting the product code from the product-to-be-purchased table 109 is not limited to the timing at which the purchase-target product is registered in the product registration table 110, but may be the timing at which the account processing of the product registered in the product registration table 110 is executed or another timing.

The display control unit 1010 controls the display device 104 to display various processing screens on the display device 104. For example, the display control unit 1010 displays, on the display device 104, a product-to-be-purchased registration screen, which will be described below, as a processing screen regarding a product to be purchased. For example, the display control unit 1010 displays a screen indicating the above-mentioned sales product list information as the processing screen regarding a product to be purchased. For example, the display control unit 1010 displays, on the display device 104, the above-mentioned product registration screen as the processing screen regarding a purchase-target product. For example, the display control unit 1010 displays, on the display device 104, a screen regarding the account processing for making a payment of the purchase-target product as the processing screen regarding a purchase-target product. The display control unit 1010 is an example of a display control unit. Specifically, the display control unit 1010 displays, on the display device 104, a screen regarding the account processing by the account processing unit 1011. That is, the display control unit 1010 displays, on the display device 104, a screen for accepting an input of information necessary for executing the account processing by the account processing unit 1011.

Alternatively, the display control unit 1010 displays, on the display device 104, a screen regarding the account processing by the accounting apparatus 30. That is, the display control unit 1010 displays, on the display device 104, a screen for providing information to the accounting apparatus 30. For example, the display control unit 1010 displays, on the display device 104, a two-dimensional code or the like indicating the information registered in the product registration table 110. Thus, the display control unit 1010 causes the accounting apparatus 30 to read the information registered in the product registration table 110.

The account processing unit 1011 executes the account processing of making a payment of the purchase-target product. The account processing unit 1011 is an example of an accounting unit. That is, the account processing unit 1011 executes the account processing of making a payment of the product registered in the product registration table 110. Specifically, the account processing unit 1011 reads a code symbol to execute the account processing or execute the account processing using a credit card.

The notification control unit 1012 performs notification in the case where the set period has elapsed since the product was registered in the product-to-be-purchased table 109. The notification control unit 1012 is an example of a notification unit. More specifically, the notification control unit 1012 compares the registration date and time registered in the product-to-be-purchased table 109 with the current date and time to determine whether or not the set period has elapsed since the product was registered. The notification control unit 1012 stands by in the case where the set period has not elapsed since the product was registered. Meanwhile, in the case where the set period has elapsed since the product was registered, the notification control unit 1012 notifies that the set period has elapsed since the product was registered in the product-to-be-purchased table 109. Note that notification of the product deleted from the product-to-be-purchased table 109 by the deletion control unit 1009 is not performed even if the set period has elapsed since the product was registered because the above-mentioned registration date and time is also deleted from the product-to-be-purchased table 109. That is, the notification control unit 1012 notifies that the set period has elapsed in the case where the product is not registered in the product registration table or in the case where the account processing is not performed on the product even after the set period has elapsed since the product was registered in the product-to-be-purchased table 109. Thus, the notification control unit 1012 prompts the user to purchase the product registered in the product-to-be-purchased table 109. Note that the set period may be an arbitrary changeable period or a fixed period.

The controller 201 of the store server 20 expands the control program 207 stored in the storage device 202 in the RAM and operates in accordance with the control program 207, thereby generating each function unit in the RAM. Specifically, the controller 201 of the store server 20 executes the functions of a communication control unit 2001, a similarity-degree calculation unit 2002, a product specification unit 2003, and a sales product providing unit 2004 shown in FIG. 8 as function units.

The communication control unit 2001 controls the communication device 203 to communicate with, for example, the portable terminal 10 via the network 2.

The similarity-degree calculation unit 2002 calculates the similarity degree between the feature amount included in the product inquiry information from the feature-amount extraction unit 1005 of the portable terminal 10 and the inquiry feature amount. More specifically, in the case where the communication control unit 2001 has received the above-mentioned product inquiry information via the communication device 203, the similarity-degree calculation unit 2002 calculates the similarity degree between the feature amount of the product inquiry information and the inquiry feature amount of each of a plurality of products registered in the product master 208. Note that the similarity degree indicates to what extent all or a part of the feature amount extracted by the feature-amount extraction unit 1005 is similar in the case where the inquiry feature amount of 100% is represented as the “similarity: 1.0”.

The product specification unit 2003 specifies, on the basis of the similarity degree calculated by the similarity-degree calculation unit 2002, the product having the feature amount of the above-mentioned product inquiry information. More specifically, the product specification unit 2003 determines, in the case where the similarity degree calculated by the similarity-degree calculation unit 2002 is equal to or greater than a threshold value, that it corresponds to the product having the similarity degree that is equal to or greater than the threshold value. That is, the product specification unit 2003 determines that it is a product of the inquiry feature amount, which has the similarity degree that is equal to or greater than the threshold value.

Note that the product specification unit 2003 may cause, in the case where no similarity degree is equal to or greater than the threshold value, the communication control unit 2001 to transmit, to the portable terminal 10, information for requesting to transmit the feature amount again. Further, in the case where no similarity degree is equal to or greater than the threshold value, the product specification unit 2003 may cause the communication control unit 2001 to transmit, to the portable terminal 10, product candidates. The product specification unit 2003 specifies, in the case where the feature amount is received again from the portable terminal 10, the product on the basis of the similarity degree calculated again. Further, the product specification unit 2003 specifies, in the case where a product has been selected from the product candidates by the portable terminal 10, the product on the basis of the selection result.

The sales product providing unit 2004 provides the portable terminal 10 with a list of products sold in the retail store, of the products registered in the product-to-be-purchased table 109. More specifically, the sales product providing unit 2004 compares, in the case where the communication control unit 2001 has received the product-to-be-purchased table 109 from the portable terminal 10, the received product-to-be-purchased table 109 and the product master 208 of the storage device 202 with each other. Thus, the sales product providing unit 2004 extracts, in the case where the same product as the product registered in the product-to-be-purchased table 109 is registered in the product master 208, product information of the corresponding product. Further, the sales product providing unit 2004 generates sales product list information that shows a list of products sold in the retail store, of the products registered in the product-to-be-purchased table 109. The sales product providing unit 2004 causes the communication control unit 2001 to transmit the sales product list information to the portable terminal 10 that has transmitted the product-to-be-purchased table 109.

The controller 301 of the accounting apparatus 30 expands the control program 311 stored in the storage device 302 in the RAM and operates in accordance with the control program 311, thereby generating each function unit in the RAM. Specifically, the controller 301 of the accounting apparatus 30 executes the functions of a communication control unit 3001, a purchase-target-product input unit 3002, and an account processing unit 3003 shown in FIG. 8 as function units.

The communication control unit 3001 controls the communication device 303 to communicate with, for example, the store server 20 via a network.

The purchase-target-product input unit 3002 accepts an input of information regarding a purchase-target product in order to execute account processing of the purchase-target product registered by the portable terminal 10. More specifically, the purchase-target-product input unit 3002 accepts, from the portable terminal 10, an input of information registered in the product registration table 110. For example, the purchase-target-product input unit 3002 may accept information registered in the product registration table 110 by causing the scanner 306 to read a code symbol indicating the information, may accept information registered in the product registration table 110 by receiving it through short-range wirelessly communication, or may accept the information by another method.

The account processing unit 3003 controls the deposit/withdrawal device 309 to execute the account processing. More specifically, the account processing unit 3003 executes the account processing on the basis of the accounting information accepted by the purchase-target-product input unit 3002. The account processing unit 3003 calculates, in the case where money is put to the deposit/withdrawal device 309, the total amount of money. Further, the account processing unit 3003 calculates change by subtracting the total amount of purchase-target products from the total amount of money put to the deposit/withdrawal device 309. The account processing unit 3003 then causes the deposit/withdrawal device 309 to discharge the change.

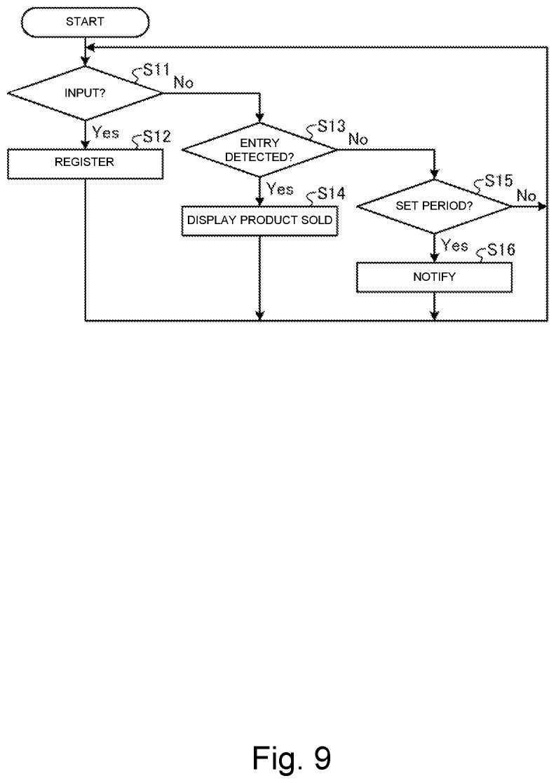

Next, the operation of the product sales system 1 according to this embodiment will be described. FIG. 9 a flowchart showing an example of out-of-store processing executed by the portable terminal 10 according to the embodiment. The out-of-store processing is processing executed by the portable terminal 10 outside the store.

In Step S11 of FIG. 9, the product-to-be-purchased registration unit 1006 of the controller 101 determines whether or not information (product code) for specifying a product has been input in the product-to-be-purchased registration screen for registering a product to be purchased. That is, the product-to-be-purchased registration unit 1006 accepts the input of a product code acquired by decoding a code symbol included in image data of the product imaged by the imaging device 106, a product code acquired by making an inquiry for the store server 20, or a product code acquired by the operation of a customer, or the like.

In the case where it is determined in Step S11 that information for specifying the product has been input (Step S11; Yes), the processing of the controller 101 proceeds to Step S12. In Step S12, the product-to-be-purchased registration unit 1006 of the controller 101 registers, in the product-to-be-purchased table 109, the product specified by the information for specifying the product, as a product to be purchased.

In the case where it is determined in Step S11 that information for specifying the product has not been input (Step S11; No), the processing of the controller 101 proceeds to Step S13. In Step S13, the sales product request unit 1007 of the controller 101 determines whether or not the entry of a customer having the portable terminal 10 has been detected.

In the case where it is determined that the entry has been detected (Step S13; Yes), the processing of the controller 101 proceeds to Step S14. In Step S14, the display control unit 1010 of the controller 101 displays products sold in the store (sales product list information), of the products registered in the product-to-be-purchased table 109 (see Step S12).

In the case where it is determined in Step S13 that the entry has not been detected (Step S13; No), the processing of the controller 101 proceeds to Step S15. In Step S15, the notification control unit 1012 of the controller 101 determines whether or not the set period has elapsed since a product to be purchased was registered in the product-to-be-purchased table 109. In the case where it is determined that the set period has not elapsed (Step S15; No), the processing of the controller 101 returns to Step S11.

In the case where it is determined in Step S15 that the set period has elapsed (Step S15; Yes), the processing of the controller 101 proceeds to Step S16. In Step S16, the notification control unit 1012 of the controller 101 notifies that the set period has elapsed since a product to be purchased was registered. Thus, the notification control unit 1012 prompts the user to purchase the product to be purchased.

In this way, the controller 101 of the portable terminal 10 finishes the out-of-store processing.

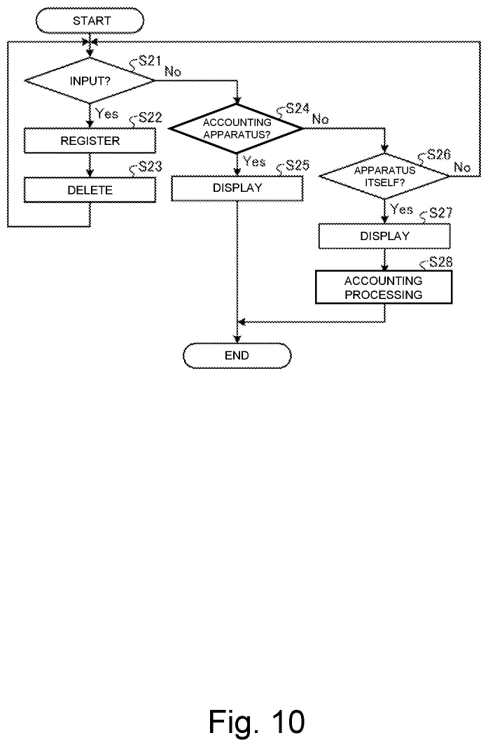

FIG. 10 is a flowchart showing an example of in-store processing executed by the portable terminal 10 according to the embodiment. The in-store processing is processing executed by the portable terminal 10 in the store.

In Step S21 of FIG. 10, the product registration unit 1008 of the controller 101 determines whether or not information for specifying a product has been input in the product registration screen for registering a purchase-target product. That is, the product registration unit 1008 accepts the input of a product code acquired by decoding a code symbol included in image data of the imaged product, a product code acquired by making an inquiry for the store server 20, or a product code acquired by the operation of a customer, or the like.

In the case where it is determined in Step S21 that information for specifying the product has been input (Step S21; Yes), the processing of the controller 101 proceeds to Step S22. In Step S22, the product registration unit 1008 of the controller 101 registers, in the product registration table 110, the product specified by the information for specifying the product, as a purchase-target product.

Next, in Step S23, the deletion control unit 1009 of the controller 101 deletes the same product as the product registered in the product registration table 110 from the product-to-be-purchased table 109 (see Step S12). Note that the deletion control unit 1009 does not execute the above-mentioned deletion in the case where the same product as the product registered in the product registration table 110 is not registered in the product-to-be-purchased table 109.

In the case where it is determined in Step S21 that information for specifying the product has not been input (Step S21; No), the processing of the controller 101 proceeds to Step S24. In Step S24, the operation control unit 1002 of the controller 101 determines whether or not the operation device 105 has accepted an operation of a customer who executes account processing by the accounting apparatus 30.

In the case where it is determined that an operation of a customer who executes account processing by the accounting apparatus 30 has been accepted, the processing of the controller 101 proceeds to Step S25. In Step S25, the display control unit 1010 of the controller 101 displays, on the display device 104, a screen regarding account processing by the accounting apparatus 30.

In the case where it is determined in Step S24 that an operation of a customer who executes account processing by the accounting apparatus 30 has not been accepted (Step S24; No), the processing of the controller 101 proceeds to Step S26. In Step S26, the operation control unit 1002 of the controller 101 determines whether or not an operation of executing account processing by the portable terminal 10 itself has been accepted. In the case where it is determined that an operation of executing account processing by the portable terminal 10 has not been accepted (Step S26; No), the processing of the controller 101 returns to Step S21.

In the case where it is determined in Step S26 that an operation of executing account processing by the portable terminal 10 has been accepted (Step S26; Yes), the processing of the controller 101 proceeds to Step S27. In Step S27, the display control unit 1010 of the controller 101 displays, on the display device 104, a screen regarding the account processing by the account processing unit 1011.

Subsequently, in Step S28, the account processing unit 1011 of the controller 101 executes account processing of the product registered in the product registration table 110.

In this way, the controller 101 of the portable terminal 10 finishes the in-store processing.

As described above, the portable terminal 10 according to this embodiment registers a product to be purchased, which is desired to be purchased in the future, outside the retail store, or the like. Further, the portable terminal 10 executes product registration processing of registering a purchase-target product in a sales floor or the like of the retail store. The portable terminal 10 then displays, on the display device 104, a screen regarding account processing of making a payment of the product registered by the product registration processing. For example, the portable terminal 10 displays, on the display device 104, a code symbol to be read by the accounting apparatus 30, or displays, on the display device 104, a screen for executing the account processing using a credit card or the like. As a result, the portable terminal 10 is capable of causing the customer himself/herself to execute the product registration processing and the account processing for the product that has been registered in advance by the customer. That is, the portable terminal 10 is capable of causing the customer himself/herself to execute the account processing.

The programs executed by the respective apparatuses according to the above-mentioned embodiments and modifications are provided by being incorporated in advance in a storage medium (ROM or a storage device) included in the respective apparatuses, but the embodiments and modifications are not limited thereto. The programs executed in the respective apparatuses may be recorded on, for example, a computer-readable recording medium such as a CD-ROM, a flexible disk (FD), a CD-R, and a DVD (Digital Versatile Disk) in an installable format or an executable format and provided. Further, the storage medium is not limited to a medium independent of a computer or an incorporated system, and includes a storage medium in which a program transmitted via a LAN, the Internet, or the like is downloaded and stored or temporarily stored.

Further, the programs executed by the respective apparatuses according to the above-mentioned embodiments and modifications may be stored in a computer connected to a network such as the Internet, and may be provided by being downloaded via a network, or may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portable terminal that executes account processing of a purchase-target product, comprising:
an imaging device that images a product and generates image data of the imaged product;
an input device that inputs identification information for specifying the product;
a storage device that stores a product-to-be-purchased table for registering information regarding a product to be purchased, and a product registration table for registering information regarding a purchase-target product;
a display device that displays a processing screen regarding the product to be purchased and the purchase-target product; and
a controller that
registers, where the product to be purchased is imaged by the imaging device, information regarding a product specified by the image data generated by the imaging device in the product-to-be-purchased table,
registers, where identification information for specifying the purchase-target product is input by the input device after the information regarding a product is registered in the product-to-be-purchased table, information regarding a product specified by the input identification information in the product registration table, and
displays, on the display device, a screen regarding account processing of the product whose information is registered in the product registration table.

2. The portable terminal according to claim 1, wherein
the controller deletes, where information regarding the purchase-target product is included in information regarding the product registered in the product-to-be-purchased table, information regarding the same product as the purchase-target product from the product-to-be-purchased table.

3. The portable terminal according to claim 2, wherein
the controller deletes, where the information regarding the product registered in the product-to-be-purchased table is registered in the product registration table, information regarding the product registered in the product registration table from the product-to-be-purchased table.

4. The portable terminal according to claim 2, wherein
the controller deletes, where accounting processing of the product whose information is registered in the product registration table is executed, the information regarding the product on which the accounting processing has been performed from the product-to-be-purchased table.

5. The portable terminal according to claim 1, wherein
the controller displays, where it is detected that a customer has entered the retail store selling products, list information of products sold in the retail store, of the products registered in the product-to-be-purchased table on the display device.

6. The portable terminal according to claim 1, wherein
the controller notifies a customer of that a set period has elapsed since the information regarding the product to be purchased was registered in the product-to-be-purchased table.

7. The portable terminal according to claim 6, wherein
information regarding the product registered in the product-to-be-purchased table includes registration date and time of the registration, and
the controller
deletes, where information regarding the purchase-target product is included in information regarding the product registered in the product-to-be-purchased table, information regarding the same product as the purchase-target product from the product-to-be-purchased table, and
determines whether or not the set period has elapsed since the information regarding the product to be purchased was registered by comparing the registration date and time registered in the product-to-be-purchased table and current date and time with each other.

8. The portable terminal according to claim 1, further comprising
an operation device that accepts an operation of a customer who executes account processing, wherein
the controller displays, where the operation device accepts the operation of the customer, a screen regarding account processing of the product whose information is registered in the product registration table on the display device.

9. The portable terminal according to claim 8, further comprising
a communication device that executes communication with an external accounting apparatus, wherein
the controller displays, in accordance with the operation of the customer accepted by the operation device, one of a screen regarding account processing by the accounting apparatus and a screen regarding account processing by the portable terminal itself on the display device.

10. An information processing method for a portable terminal that executes account processing of a purchase-target product, comprising:
storing, in a storage device, a product-to-be-purchased table for registering information regarding a product to be purchased, and a product registration table for registering information regarding a purchase-target product;
registering, where the product to be purchased is imaged by an imaging device, information regarding a product specified by image data generated by the imaging device in the product-to-be-purchased table;
registering, where identification information for specifying the purchase-target product is input by the input device after the information regarding a product is registered in the product-to-be-purchased table, information regarding a product specified by the input identification information in the product registration table; and
displaying, on the display device, a screen regarding account processing of the product whose information is registered in the product registration table.
